(19) United States
(12) Patent Application Publication
(10) Pub. No.: US 2015/0327715 A1
(43) Pub. Date: Nov. 19, 2015

(54) METHOD AND DEVICE FOR POURING OUT MILK FROTH, LIQUIDS OR THE LIKE

(71) Applicant: STEINER AG WEGGIS, Weggis (CH)

(72) Inventor: Adrian Steiner, Weggis (CH)

(21) Appl. No.: 14/553,462

(22) Filed: Nov. 25, 2014

(30) Foreign Application Priority Data
Nov. 29, 2013 (CH) 01989/13

(51) Int. Cl. A47J 31/44; A23F 5/24

(52) U.S. Cl. CPC A47J 31/4496; A23F 5/24

(57) ABSTRACT

Method for producing patterns from milk froth and similar froth-, cream- or powder-like products in the preparation of coffee and similar drinks, according to which milk froth is automatically added to the coffee by a device controlled spatially in two or three coordinate directions, an aesthetically decorative milk froth pattern being produced by mixing the milk froth with the coffee. The device provided for this purpose is made in the form of a robot. It is provided with individually operable articulated arms for guiding a milk froth dispenser in a respective coordinate direction.

### FIELD OF THE INVENTION

The invention relates to a method for pouring out milk froth, liquids or the like from a device wherein, after pouring out a drink, preferably coffee, into a container, a specific amount of milk froth or the like is added which remains on the surface of the drink, preferably coffee, that has been poured in, as well as to a device for implementing the method.

### BACKGROUND OF THE INVENTION

In the preparation of drinks, in particular coffee, widely known among experts by the name “latte type”, milk froth is added to the coffee by hand from a jug or the like in such a way that a graphic pattern with figural or abstract motifs, that is determined by the creativity and skill of the person carrying out the task, is produced on the coffee. This type of preparation is particularly time-consuming and requires a lot of practice until a person can form such motifs in an aesthetically pleasing manner.

### OBJECTS AND SUMMARY OF THE INVENTION

In contrast, it is the object of the invention to devise a method of the type specified at the start by means of which it is possible to prepare coffee and similar products en masse in a time-saving manner.

According to the invention, this object is achieved by the milk froth being added while the drink is being poured out in such a way that said milk froth produces a graphic pattern on the surface of the poured in drink.

In this way, largely consistent milk froth patterns can be produced in a relatively short time according to motifs that can be selected in advance independently of the technical skill of the user. This makes it possible to produce coffee of the “latte type” en masse with qualitatively impeccable milk froth patterns.

This invention also makes provision such that the device by means of which the coffee milk froth is added is controlled in three coordinate directions preferably aligned equiangularly to one another. According to this procedure the coffee can be provided with relief-like milk froth patterns.

The invention also makes provision such that the control of the device adding the milk froth can be programmed, the user being able to select, for example, his/her preferred milk froth pattern from a plurality of motifs.

The device for implementing the method according to the invention is equipped with individually operable articulated arms for guiding a milk froth dispenser in a respective coordinate direction.

In the embodiment illustrated the device, as a robot, is equipped with individually controlled rotary drives which are arranged in an equiangular triangle and are provided with operating levers for operating the articulated arms.

For holding the coffee and the milk froth coffee cups or similar containers are generally used, the dimensions of which are not standardised and the position of which relative to the milk froth dispenser varies within specific limits. For this reason the invention also makes provision such that the device for implementing the method according to the invention is provided with sensors for recognising the height of the cup and the position of the cup.

So that the user is protected from the moving parts of the device, the device can be provided with a safety system. The latter can have a light grid or a light curtain that halts operation as soon as a foreign body interrupts it. The safety system can also include a protective hood by means of which the device is screened during the preparation process.

The device according to the invention is designed such that it can be fully integrated into a conventional coffee machine. However, it is also possible to design the device as a self-contained module.

### BRIEF DESCRIPTION OF THE DRAWINGS

The invention is described in more detail below by means of an exemplary embodiment with reference to the drawings. These show as follows:

FIG. 1 is a device according to the invention in a perspective diagrammatic view; and

FIG. 2 is a perspective view of a second embodiment of a device according to the invention with linear motors as drive means.

### DETAILED DESCRIPTION OF THE INVENTION

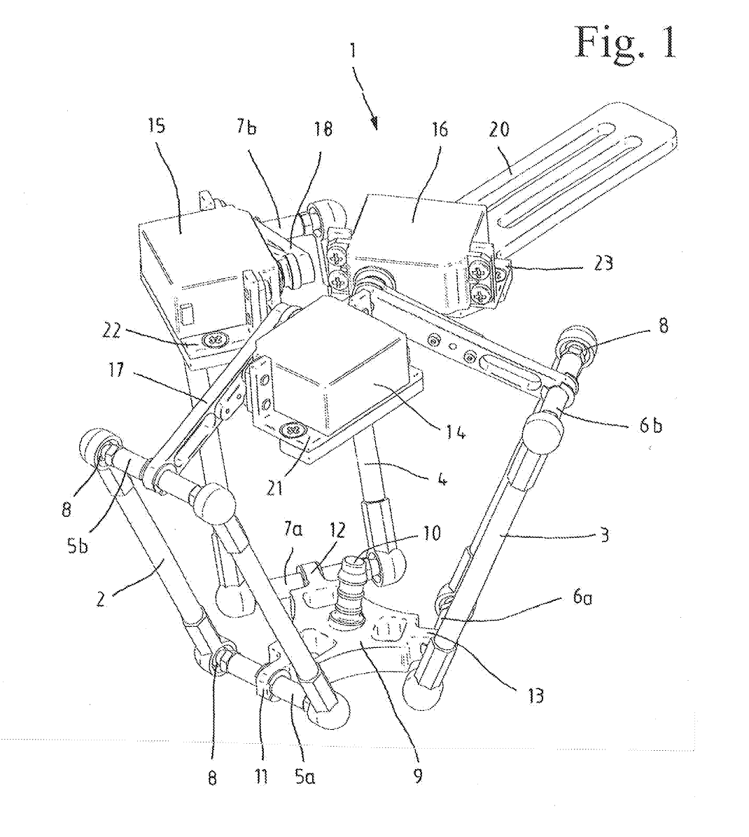

FIG. 1 shows a device 1 for a method wherein, after pouring out a drink, a specific amount of milk froth or the like, which remains on and/or beneath the surface of the poured out drink, is added to a container. Under normal circumstances, for example, the milk froth poured in mixes with the coffee in the surface region of the latter, and part of the milk froth remains above this surface.

A suitable drink is preferably coffee for the production of a cappuccino. However, it can also be hot or cold chocolate, milk or some other mixed drink. Instead of milk froth, a different froth or cream-like medium could also be poured on.

According to the invention the milk froth or the like is added in a controlled manner during pouring such that a graphic pattern is produced on the surface of the poured out drink by this froth.

By this method one can produce the form of a heart, a flower, a plant, a face, a company logo or any motif as the graphic pattern.

The device 1 according to the invention basically consists of three articulated arms 2, 3, 4 that can be moved individually by means of rotary drives 14, 15, 16, a carrier plate 9 connected flexibly to the latter and a discharge port connected to a milk froth dispenser 10 (not detailed). These are connected in pairs by cross members 5a, 5b; 6a, 6b and 7a, 7b to ball joints 8 which guarantee the agility of the articulated arms on all sides. This carrier plate 9 is held on the lower cross members 5a, 6a, 7a. These three suspension bearings 11, 12, 13 form the corners of an equiangular triangle. This device 1 is made in the form of a robot here and is operated by programme control.

The articulated arms 2,3,4 are operated by means of rotary drives 14, 15, 16 using operating levers 17, 18 19 which act on the upper cross members 5b, 6b, 7b of the articulated arms. The rotary drives 14, 15, 16 are controlled according to a specified programme such that each articulated arm is moved in any coordinate direction. In the present exemplary embodiment these directions are arranged at angles of 120° in relation to one another. The corresponding arrangement is also produced for the rotary drives 14, 15, 16 on the supporting frame, of which only the carrier plate 20 and the three motor carriers 21, 22, 23 can be seen in FIG. 1.

During the preparation procedure the articulated arms 2,3,4 are moved by the rotary drives 14, 15, 16 such that they can guide the discharge port 10 for the milk froth precisely over the surface of the drink to be decorated according to the geometry of the respectively selected milk froth pattern. The corresponding control is advantageously a component part of a self-contained device-specific software. The programming also includes the selectability of the pattern from a plurality of programmed motifs.

The device 1 according to the invention is characterised in that it is stable and robust and guarantees the required operational safety when operated continuously. The device enables precise and sensitive guidance of the jet of milk.

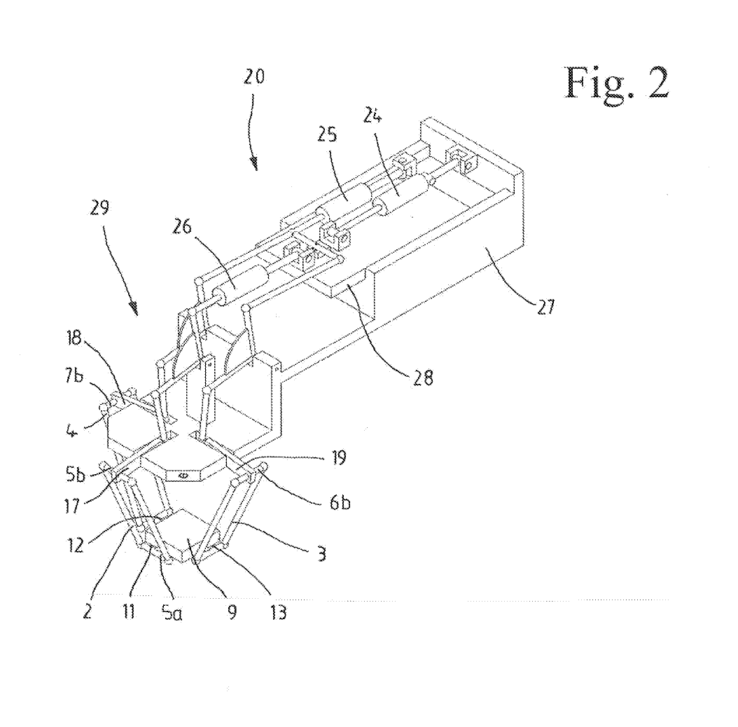

A device 20 according to FIG. 2 substantially differs from that according to FIG. 1 in that it is provided with linear motors instead of the rotary drives 14, 15, 16. The linear motors 24, 25, 26 are arranged parallel to one another within a housing 27 with a linear carriage 28. The latter can be moved to and fro by the linear motor 24, while the two other linear motors 25, 26 are mounted on the linear carriage 28, and by means of an additional articulation system 29 the articulated arms 2,3,4 can move in the direction of coordinates x, y, z. The operating lever 17, 18, 19 and the suspension bearing 11, 12, 13 of the carrier plate 9 are arranged at right angles to one another for the milk froth dispenser.

The movement sequence of the jet of milk froth during the automatic generation of a two-dimensional milk froth pattern takes place in the x and the y direction on the surface of the poured out drink.

Used as the basis normally is a coffee cup with an outside diameter of for example 80 mm which, in comparison to the diameter of the outlet opening 41 at the discharge port 10, is advantageously a number of times greater so that this motif can be produced with the required accuracy. The starting position of the jet of milk froth is for example approx. 30 mm away from the zero point in the y axis. In the subsequent pouring out phase a movement of the jet of milk froth of (on average) approx. 25 mm back in the y axis and lateral swivel movements of approx. 20 mm in the x axis take place.

Additionally, a superordinate or a subsequent movement in z direction can be provided, which enables such a three dimensional figure. These movements are accordingly respectively specified for the chosen patterns.

These devices according to the invention can either be fully integrated into a coffee machine or be made in the form of a self-contained module.

The invention is sufficiently displayed by the exemplary embodiments described above. However, it could of course also be illustrated by other variations. Thus, for example, an outlet opening for the milk froth that is made to be elongate or differently shaped rather than with an approximately round cross section could be provided so that a pattern would also form on the surface of the drink.

In principle, the milk froth or the like could be poured out by being interrupted and then being displaced in two or three coordinate directions (x, y, z) along the surface of the poured in drink.

1. A method for pouring out milk froth, liquids or the like from a device wherein, after pouring out a drink, preferably coffee, into a container, a specific amount of milk froth or the like is added which remains on and/or beneath the surface of the drink, preferably coffee, that has been poured in, wherein while being poured out, the milk froth is added in a controlled manner such that said milk froth produces a graphic pattern on the surface of the poured in drink.

2. The method according to claim 1, wherein while being poured out, the milk froth is added by being moved in a controlled manner in two or three coordinate directions.

3. The method according to claim 2, wherein this movement in this controlled manner of the milk froth can be provided in x and/or y axis and an additional superordinate and/or a subsequent movement in z direction, which enables such a three dimensional figure respectively.

4. The method according to claim 1, wherein control of the addition of the milk froth or similar can be programmed.

5. The method according to claim 1, wherein the form of a heart, a flower, a plant or the like can be produced as a graphic pattern.

6. A device for implementing the method according to claim 1, wherein the milk froth can be added to the coffee automatically by a device controlled spatially in two or three coordinate directions.

7. The device according to claim 6, wherein it is provided with individually operable articulated arms for guiding a milk froth dispenser.

8. The device according to claim 6, wherein it is made in the form of a robot with individually controlled rotary drives which are arranged in an equiangular triangle and are provided with operating levers for operating the articulated arms.

9. The device according to claim 6, wherein it is equipped with linear motors arranged parallel to one another and is provided with an additional articulation system with operating levers arranged perpendicularly to one another for the articulated arms.

10. The device according to claim 6, wherein the coffee and the milk froth can be poured into a coffee cup or a similar container, and the device is provided with sensors for recognising the height of the cup and the position of the cup.

11. The device according to claim 6, wherein it is provided with a safety system for protecting the user.

12. The device according to claim 11, wherein the safety system contains a light grid or a light curtain that halts operation as soon as a foreign body interrupts it.

13. The device according to claim 11, wherein the safety system has a protective hood by means of which the device is screened during the preparation process.

14. The device according to claim 6, wherein it can be fully integrated into a coffee machine.

15. The device according to claim 6, wherein it is made in the form of a self-contained module.
